(19) United States
(12) Patent Application Publication
(10) Pub. No.: US 2009/0169129 A1
(43) Pub. Date: Jul. 2, 2009

(54) Method for automatically transforming color space and prospect of an imaging device

(76) Inventors: Yun-Chin Li, Banciao City (TW); Chin-Lung Yang, Toufen Township (TW); Shih-Chang Han, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/285,840

(22) Filed: Oct. 15, 2008

(30) Foreign Application Priority Data
Dec. 31, 2007 (TW) 96151526

(51) Int. Cl. G06K 9/40

(52) U.S. Cl. 382/274

(57) ABSTRACT

A method for automatically transforming color space and prospects of an imaging device is disclosed. The method at least includes: selecting a source image and a target image; transforming color space automatically wherein the color spaces of the two images are respectively transformed into another color space; matching levels, wherein features are grouped and the most similar adjacent field is searched; and copying the chrominance values—distributing the best matched brightness level distributions of said another color space of the source image and the target image, finding the pixels corresponding to the target image, and then copying the chrominance values to the source image to transform prospects.

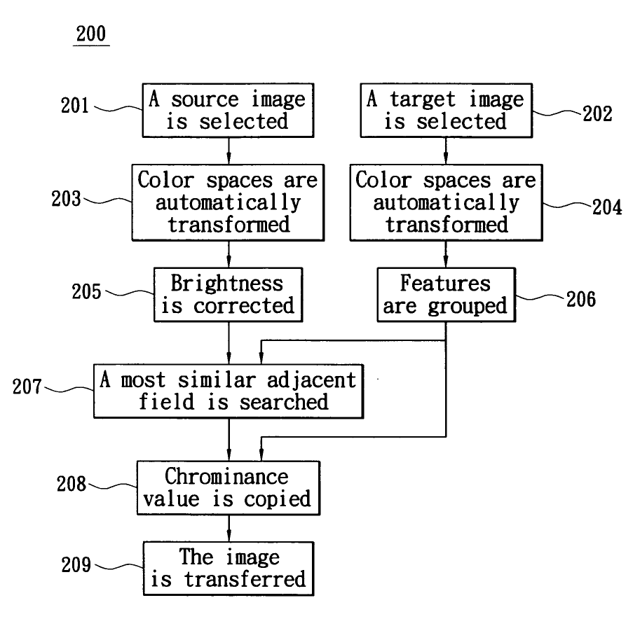

### BACKGROUND OF THE INVENTION

1. Field of the Invention

The present invention relates to a method for automatically transforming color space and prospect of an imaging device.

2. Description of Related Art

Generally, imaging devices, such as cameras, have different shooting modes, which are transformed with different prospects to show different visual effects, such as retro, black and white, and emboss, etc.

The shooting modes for different prospects provided in prior arts are simple and have few variations, which can be imitating in regard to user operating preference. Traditionally, the prospects are transformed via color space transforming, color temperature, or special periphery process. For example, high color images shot in daytime are transformed into low color images shot in dusk by simply changing the gain of colors or color correction matrix. Such prospect transforming method is performed by changing the color temperature, but the final effect would appear factitious, and the shooting modes are limited.

Consequently, because of the limitations described above, the applicant strives via experience and research to develop the present invention, which can effectively improve the limitations described above.

### SUMMARY OF THE INVENTION

The object of the present invention is to provide a method for automatically transforming color space and prospect of an imaging device, via this method the prospect transformation is achieved. The color of the images shot via the method is more natural in terms of color, and the shooting modes are varied

For achieving the object described above, the present invention provides a method for automatically transforming color space and prospect of an imaging device. The method at least includes: selecting a source image and a target image; transforming color space automatically, wherein the color space of the source image and the target image are respectively transformed into another color space to achieve corresponding brightness level distributions in said another color space of the source image and the target image, and an appearance rate of a plurality of pixels of the source image and the target image to a plurality of brightness level values in said another color space are respectively calculated according to the brightness level distributions, and each pixel has a chrominance value; matching levels—first, performing feature grouping respectively for the brightness level distributions of said another color space of the source image and the target image, then find the most similar adjacent field in order to locate the best matched brightness level distributions of said another color space of the source image and the target image; and copying the chrominance value—distributing the best matched brightness level distributions of said another color space of the source image and the target image, finding the pixels corresponding to the target image, and then copying the chrominance values to the source image to transform prospects.

The present invention further provides a method for automatically transforming color space and prospect of an imaging device, the method at least includes: selecting a source image and a target image; transforming color space automatically, wherein the color spaces of the source image and the target image are respectively transformed into another color space to achieve corresponding brightness level distributions in said another color space of the source image and the target image, and an appearance rate of a plurality of pixels of the source image and the target image to a plurality of brightness level values in said another color space are respectively calculated according to the brightness level distributions, and each pixel has a chrominance value; correcting brightness, wherein the brightness level distributions of said another color space of the source image is non-linearly transformed into another brightness and level values that is most similar to that of said another color space of the target image, in order to achieve another brightness level distributions of said another color space of the source image, and calculate to obtain the pixels of brightness correcting value of the source image; grouping feature—calculating the pixels of the target image to achieve the pixels' feature value; searching the most similar adjacent field—normalizing the pixels of brightness correcting value of the source image with the target image's pixels' feature value, and then searching and comparing to find the best match value; and copying the chrominance values—distributing the best matched brightness level distributions of said another color space of the source image and the target image, finding the pixels corresponding to the target image, and then copying the chrominance values to the source image to transform prospects.

In brief, the present invention can be summarized: the prospect transformation is achieved via selecting a source image and a target image, respectively transforming color space automatically and matching levels, or correcting the brightness of the source image, and finally copying the corresponding brightness and chrominance value of the target image to the source image.

The features and technology of the present invention can be further understood by reference to the detailed description which follows taken in conjunction with the accompanying drawings, and the accompanying drawings are provided only for reference and explain and not as limiting the present invention.

### BRIEF DESCRIPTION OF THE DRAWINGS

The Figure is a flow chart showing a method of a preferred embodiment according to the present invention.

### DETAILED DESCRIPTION OF PREFERRED EMBODIMENTS

Please refer to the FIGURE showing a preferred embodiment flow chart of a method 200 according to a method for automatically transforming color space and prospect of an imaging device of the present invention.

The method 200 includes: in step 201, a source image is selected; in step 202, a target image is selected; in step 203, color spaces are automatically transformed; in step 204, color spaces are automatically transformed; in step 205, brightness is corrected; in step 206, features are grouped; in step 207, a most similar adjacent field is searched; in step 208, chrominance values are copied; and, in step 209, the image is transferred, thus, the prospect is transformed.

Step 201

A source image is selected. For example, an image shot in summer is defined as the source image, or, an image shot in Taipei is defined as the source image.

Step 202

A target imaging is selected. For example, an image shot in autumn is defined as a target image according to the aforementioned image shot in summer, which is defined as the source image, or, an image shot in Kaohsiung is defined as a target image according to the aforementioned image shot in Taipei, which is defined as the source image. Further, for the present embodiment, the target image may be the image having several specific prospect modes pre-stored in a camera, and the prospects are respectively named. Users can select one of the pre-stored prospect modes or use the one provided by them.

Step 203

Color spaces are automatically transformed, that is, one color space of the source image is transformed into another color space of the source image to achieve corresponding brightness level distributions in said another color space of the source image. An appearance rate of a plurality of pixels of the source image and the target image to a plurality of brightness level values in said another color space are respectively calculated according to the brightness level distributions, and each pixel has a chrominance value. For example, the color space of the source image includes at least: RGB or CIE XYZ; another color space of the source image includes at least: CIE LAB (lαβ) or YUV (YCbCr).

For the RGB, R indicates red value, G indicates green value, and B indicates blue value. For CIE XYZ, X indicates red stimulus value, Y indicates green stimulus value, and Z indicates blue stimulus value. For CIE LAB, L indicates brightness value, A indicates from red value (positive value) to green value (negative value), and B indicates from yellow value (positive value) to blue value (negative value). For YUV, Y indicates luminance, U and V indicates chrominance.

The pixels of the source image are transformed into the brightness level values in said another color space to reduce the color relevancy. For example: for RGB, the red value, the green value, and the blue value may have relevancy. For instance, for most of the images' pixels, if the blue value is relatively big to what it is trying to represent, the red value and the green value will also be relatively big due to their relevancy. If brightness level values need to be adjusted in the color space, the changes of the brightness level values of the other two dimensionalities must be considered, which is what makes the color space transformation complex. Thus, the RGB color space may be transformed into the CIE LAB color space to make the color space transformation easier.

Step 204

Color spaces are automatically transformed, that is, one color space of the target image is transformed into said another color space of the source image to achieve corresponding brightness level distributions in said another color space of the source image. An appearance rate of a plurality of pixels of the source image and the target image to a plurality of brightness level values in said another color space are respectively calculated according to the brightness level distributions, and each pixel has a chrominance value.

Step 205

The brightness is corrected, for said another color space, the brightness level distributions of the source image is non-linearly transformed into another brightness level distributions that is most similar to that of said another color space of the target image, in order to achieve another brightness level distributions of the source image in said another color space, and calculate to obtain the pixels of brightness correcting value of the source image.

Step 206

Features are grouped; the pixels of the target image are calculated to achieve the target image's pixels' feature value.

For feature grouping, the pixels of the target image, 5×5 part size at least, are calculated for the brightness mean, the standard deviation, and the gradient. The statistics result is defined as the target image's pixels' feature value. Because the redundancy of the brightness level distributions in said another color space of the source image is very high, so the K-mean grouping statistics is used to simply group to reduce the searching space of the follow-up images. In addition, another statistics method such as the general vector quantization (VQ) may be used, a binary tree is set up, and the target image's pixels' feature value is transformed into a feature tree, thereby reducing the search space of the follow-up images.

Step 207

The most similar adjacent field is searched. After the pixels of brightness correcting value of the source image with the target image's pixels' feature value, which are achieved in step 205, are normalized, they are searched and compared to find the best match value.

Moreover, if the brightness level distributions of said another color space of the source image is most similar to that of the target image before step 205, then the brightness correcting of the source image doesn't need to be performed in step 205. If the searching speed of searching similar adjacent fields in step 207 needs to be increased, then perform feature grouping step 206 on the brightness level distributions of said another color space of the source image to achieve the source image's pixels' feature value, and then perform the similar adjacent fields searching step 207. After the features are grouped, the achieved source image's pixels' feature value and that of the target image are searched and compared to find the best match feature value between the pixels of the source image and the target image. Wherein, the levels matching step successively includes the feature grouping step 206 and the most similar adjacent field searching step 207.

Step 208

The chrominance values are copied. The best matched brightness level distributions in said another color space of the source image and the target image is distributed to find the pixels corresponding to the target image, then the pixels' chrominance values are copied to the source image finally, the source color space is transformed back to achieve a new image.

Step 209

The image is transferred to transform the prospect.

The color space transform method of the present invention first selects a source image and a target image; then transforms color space automatically, wherein each of the color space is transformed into said another color space; and then matches the color levels and group features and searches the most similar adjacent field; and lastly transfers the image to copy, wherein the color portion of the target image which is most similar to the source image is copied to the source image, thereby transforming the prospect. In the method, the K-mean grouping statistics is used to simplify grouping. Furthermore, the general vector quantization (VQ) may be used.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for automatically transforming color space and prospect of an imaging device, at least comprising:
selecting a source image and a target image;
transforming color space automatically, wherein the color space of the source image and the target image are respectively transformed into another color space to achieve corresponding brightness level distributions in said another color space of the source image and the target image, and an appearance rate of a plurality of pixels of the source image and the target image to a plurality of brightness level values in said another color space are respectively calculated according to the brightness level distributions, and each pixel has a chrominance value;
matching levels, first performing feature grouping respectively for the brightness level distributions of said another color space of the source image and the target image, then find the most similar adjacent field in order to locate the best matched brightness level distributions of said another color space of the source image and the target image; and
copying the chrominance values, distributing the best matched brightness level distributions of said another color space of the source image and the target image, finding the pixels corresponding to the target image, then copying the chrominance values to the source image to transform prospects.

2. The method according to claim 1, wherein the color space at least comprises RGB or CIE XYZ.

3. The method according to claim 1, wherein said another color space at least comprises CIE LAB (lαβ) or YUV (YCbCr).

4. The method according to claim 1, wherein the feature grouping at least comprises K-mean grouping statistics.

5. The method according to claim 1, wherein the feature grouping further comprises vector quantization statistics.

6. A method for automatically transforming color spaces and prospects of an imaging device, at least comprising:
selecting a source image and a target image;
transforming color space automatically, wherein the color space of the source image and the target image are respectively transformed into another color space to achieve corresponding brightness level distributions in said another color space of the source image and the target image, and an appearance rate of a plurality of pixels of the source image and the target image to a plurality of brightness level values in said another color space are respectively calculated according to the brightness level distributions, and each pixel has a chrominance value;
correcting brightness, wherein the brightness level distributions of said another color space of the source image is non-linearly transformed into another brightness level distributions that is most similar to that of said another color space of the target image, in order to achieve another brightness level distributions of said another color space of the source image, and calculate to obtain the pixels of brightness correcting value of the source image;
grouping feature, calculating the pixels of the target image to achieve the pixels' feature value;
searching the most similar adjacent field—normalizing the pixels of brightness correcting value of the source image with the target image's pixels' feature value, then searching and comparing to find the best match value; and
copying the chrominance values, distributing the best matched brightness level distributions of said another color space of the source image and the target image, finding the pixels corresponding to the target image, and then copying the chrominance values to the source image to transform prospects.

7. The method according to claim 6, wherein said color space at least comprises RGB or CIE XYZ.

8. The method according to claim 6, wherein said another color space at least comprises CIE LAB (lαβ) or YUV (YCbCr).

9. The method according to claim 6, wherein the feature grouping at least comprises K-mean grouping statistics.

10. The method according to claim 6, wherein the feature grouping further comprises vector quantization statistics.
